(19) United States
(12) Patent Application Publication
(10) Pub. No.: US 2014/0329985 A1
(43) Pub. Date: Nov. 6, 2014

(54) METHOD FOR PRODUCING POLYETHER ESTER POLYOLS

(71) Applicants: Klaus Lorenz, Dormagen (DE); Jörg Hofmann, Krefeld (DE); Bert Klesczewski, Koln (DE); Norber Hahn, Frechen (DE)

(72) Inventors: Klaus Lorenz, Dormagen (DE); Jörg Hofmann, Krefeld (DE); Bert Klesczewski, Koln (DE); Norber Hahn, Frechen (DE)

(21) Appl. No.: 13/994,859

(22) PCT Filed: Dec. 19, 2011
(86) PCT No.: PCT/EP2011/073162

§ 371 Date: Aug. 14, 2013

(30) Foreign Application Priority Data
Dec. 20, 2010 (EP) 10195883.3

(51) Int. Cl. C08G 18/36; C11C 3/00

(52) U.S. Cl. CPC C08G 18/36; C11C 3/00
USPC 528/74.5; 554/149; 554/227

(57) ABSTRACT

The present invention provides a process for producing polyether ester polyols on the basis of renewable raw materials, the polyether ester polyols produced by the process according to the invention, the use thereof for the purpose of producing polyurethanes, and also polyurethanes containing the polyether ester polyols according to the invention

The present invention provides a process for producing polyether ester polyols on the basis of renewable raw materials, the polyether ester polyols that are obtainable by the process according to the invention, and also the use thereof for the purpose of producing polyurethanes.

Polyether ester polyols on the basis of renewable raw materials such as fatty-acid triglycerides, sugar, sorbitol, glycerin and dimer fatty alcohols are already used in diverse ways as raw material in the production of polyurethanes. In future, the use of such components will increase further, since products from renewable sources are valued advantageously in ecological balances, and the availability of raw materials based on petrochemicals will decline in the long term.

An increased use of sugar, glycerin and sorbitol as well as oligosaccharides or polysaccharides as polyol component in polyurethane formulations is, on the one hand, opposed by the low solubility thereof in, and high incompatibility with, other polyether polyols or polyester polyols frequently employed in polyurethane-chemistry; on the other hand, by reason of their high density of hydroxyl groups these substances confer disadvantageously high OH values upon the polyol component, even in the case of low dosages.

Fatty-acid triglycerides are obtained in large quantities from renewable sources and therefore constitute an inexpensive basis for polyurethane raw materials. Especially in rigid-foam formulations this class of compounds is distinguished by a high dissolving power in respect of physical expanding agents based on hydrocarbons. One disadvantage is that only few fatty-acid triglycerides exhibit the reactive hydrogen atoms necessary for the conversion with isocyanates. Exceptions are castor oil and the rare Lesquerella oil. However, the availability of castor oil is restricted by reason of spatially limited areas of cultivation.

A further problem with the use of triglycerides in foam formulations is the incompatibility thereof with other polyol components, in particular with polyether polyols.

In the state of the art quite a few approaches to solving the problems described above have been proposed:

DE-C 33 23 880 and WO-A 2004/20497 are concerned with the use of double-metal-cyanide catalysts in the production of alkylene-oxide adducts on the basis of starter components from renewable sources with the aim of making these accessible to polyurethane chemistry. As preferred starter component, castor oil is frequently employed; also usable are oils subsequently modified with hydroxy groups. According to the disclosed processes, relatively high-molecular polyether ester polyols are accessible. However, the triglycerides that are used must, unless castor oil is employed, be modified with hydroxy groups in a separate reaction step.

According to U.S. Pat. No. 6,420,443, compatibilizers for hydrocarbon-based expanding agents can be obtained by addition of alkylene oxide to hydroxylated triglycerides. In similar manner, in DE-A 101 38 132 the use is described of OH adducts formed from castor oil or hydroxylated fatty-acid compounds and alkylene oxides as hydrophobing components in very flexible polyurethane systems.

U.S. Pat. No. 6,686,435, EP-A 259 722, U.S. Pat. No. 6,548,609, US-A 2003/0088054, U.S. Pat. No. 6,107,433, DE-A 36 30 264, U.S. Pat. No. 2,752,376, U.S. Pat. No. 6,686,435 and WO 91/05759 disclose the ring opening of epoxidised fatty-acid derivatives and the use of the products obtained in polyurethane systems. A significant disadvantage of all these processes is that the epoxide groups have to be generated from the double bonds of the fatty-acid residues in an upstream reaction step.

WO-A 2004/096744 discloses a process for hydroxylating and hydroxymethylating unsaturated fatty-acid esters, the further conversion of which by transesterification so as to form branched condensates is taught in WO-A 2004/096882. From WO-A 2004/096883 the use emerges of these OH-group-containing condensates in flexible-foam formulations.

U.S. Pat. No. 6,359,022 discloses transesterification products of hydrophobic components, for example triglycerides, phthalic-acid derivatives and polyols, as OH component in rigid-foam formulations that use alkanes as expanding agents. The polyether polyols additionally employed optionally in the polyol component have to be produced in a separate reaction step. EP-A 905 158 discloses expanding-agent emulsifying aids for rigid-foam formulations on the basis of esterification products or transesterification products of fatty-acid derivatives and alcohols. EP-A 610 714 teaches the production of hydrophobic rigid polyurethane foams by concomitant use of esterification products of OH-functional fatty-acid derivatives with low-molecular polyols.

WO-A 2006/040333 and WO-A 2006/040335 disclose hydrophobically modified polysaccharides that are obtained by esterification with fatty acids, and the use thereof as components increasing the compressive strength in flexible-foam formulations.

DE-A 196 04 177 describes the transesterification of castor oil or hydroxylated triglycerides with alkylene-oxide addition products of multifunctional starter alcohols and the use thereof as components that are stable in storage in the production of solid-matter systems curing in bubble-free manner.

DE-A 199 36481 discloses the use of long-chain castor-oil polyetherols as components for producing sound-absorbing flexible foams. The conditions of the production of the castor-oil polyetherols are not disclosed.

According to the teaching of EP-A 1 923 417, polyols that are suitable for polyurethane applications can be obtained by simultaneous conversion of starters with active hydrogen atoms and triglycerides under basic conditions with alkylene oxides. As a crucial advantage of this process it is to be emphasised that all kinds of oils of plant and animal origin are suitable for the process. It is, in particular, suitable for direct conversion of triglycerides without hydroxy groups in the fatty-acid residues into polyols with components from regenerative sources. The process claimed in EP-A 1 923 417 was elaborated further in EP-A 2 028 211 and WO-A 2009/106244 with the aim of further simplifying the regeneration processes for such polyether ester polyols. One disadvantage of the processes described in EP-A 1 923 417, EP-A 2 028 211 and WO-A 2009/106244 is that the transesterification reactions taking place by reason of the basic reaction conditions persist up until the end of the alkylene-oxide addition phase, and therefore products with non-uniform distribution of the polyether chain lengths result. The polyether ester polyols claimed in EP-A 1 923 417, EP-A 2 028 211 and WO-A 2009/106244 are therefore preferably suitable for producing polyurethane rigid foams, and less for producing polyurethane flexible foams.

The object was therefore to make available a simple process for producing polyether ester polyols on the basis of renewable raw materials. The polyether ester polyols produced in accordance with the invention are to be capable of being employed as components that are reactive towards isocyanates for the purpose of producing polyurethanes, in particular flexible foams, and are to avoid the disadvantages of the polyether ester polyols produced in accordance with the state of the art on the basis of renewable raw materials. In particular, the process should not require steps such as filtrations, treatment with adsorbents or ion-exchangers.

This object was surprisingly achieved by a process for producing polyether ester polyols (1) with an OH value from 3 mg to less than the OH value of component A), preferably from 3 mg to 120 mg KOH/g, particularly preferably from 14 mg to 75 mg KOH/g, on the basis of renewable raw materials, characterised in that
(i) a component A) with an OH value of at least 70 mg KOH/g, preferably from 130 mg to 500 mg KOH/g, particularly preferably from 180 mg to 300 mg KOH/g, is produced by the following steps
   (i-1) conversion of an H-functional starter compound A1) with one or more fatty-acid esters A2) and with one or more alkylene oxides A3) in the presence of a basic catalyst, the basic catalyst being contained in concentrations from 40 ppm to 5000 ppm, relative to the total mass of component A), and subsequent
   (i-2) neutralisation of the products from step (i-1) with sulfuric acid, characterised in that 0.75 mol to 1 mol sulfuric acid per mol catalyst employed in step (i-1) are employed, and in that the salt arising in the process remains in component A), and
   (i-3) optionally the removal of reaction water and of traces of water introduced with the acid at an absolute pressure from 1 mbar to 500 mbar and at temperatures from 20° C. to 200° C., preferably at 80° C. to 180° C.,
(ii) subsequently component A) is converted with one or more alkylene oxides B1) in the presence of a double-metal-cyanide (DMC) catalyst B2).

Further subjects of the present invention are also the polyether ester polyols produced by the process according to the invention and the use thereof for the purpose of producing polyurethanes, in particular the use thereof for the purpose of producing polyurethane flexible foams, and also polyurethanes containing the polyether ester polyols according to the invention.

In the following the process according to the invention will be described in detail:

### Step (i)

(i-1)

In one embodiment of the process according to the invention, in step (i-1) the H-functional starter compounds A1) are submitted in the reactor, mixed with the basic catalyst and also with one or more fatty-acid esters A2) and one or more alkylene oxides A3).

The fatty-acid esters A2) are preferably employed in quantities from 10 wt. % to 75 wt. %, relative to the quantity of component A) obtained in step (i). If water arises in the course of addition of the basic catalyst or if water is introduced concomitantly as solvent in the course of addition of the basic catalyst, it is advisable to remove the water before the addition of one or more fatty-acid esters A2) at temperatures from 20° C. to 200° C., preferably at temperatures from 80° C. to 180° C., in a vacuum at an absolute pressure from 1 mbar to 500 mbar and/or by stripping with inert gas. In the course of the stripping with inert gas, volatile constituents are removed by passing inert gases into the liquid phase with simultaneously applied vacuum at an absolute pressure from 5 mbar to 500 mbar. This happens advantageously at temperatures from 20° C. to 200° C., preferably at temperatures from 80° C. to 180° C., and with stirring.

By fatty-acid esters A2) in the sense according to the invention, fatty-acid glycerides, in particular fatty-acid triglycerides, and/or esters of fatty acids with an alcohol component that includes monofunctional and/or multifunctional alcohols with a molecular mass from ≧32 g/mol to ≦400 g/mol are understood. The fatty-acid esters may also carry hydroxyl-group-containing fatty-acid residues, such as, for example, in the case of castor oil. In the process according to the invention it is also possible to employ fatty-acid esters, the fatty-acid residues of which were subsequently modified with hydroxy groups, for example by epoxidation or ring opening or atmospheric oxidation.

All fatty-acid triglycerides are suitable as substrates in the process according to the invention. In exemplary manner the following may be named: cottonseed oil, peanut oil, coconut oil, linseed oil, palm-kernel oil, olive oil, maize oil, palm oil, castor oil, Lesquerella oil, rapeseed oil, soya oil, sunflower oil, herring oil, sardine oil and tallow. Fatty-acid esters of other monofunctional or multifunctional alcohols and also fatty-acid glycerides with less than three fatty-acid residues per glycerin molecule may also be employed in the process according to the invention. The fatty-acid triglycerides, fatty-acid glycerides and the fatty-acid esters of other monofunctional and multifunctional alcohols may also be employed in a mixture.

Monofunctional or multifunctional alcohols that are suitable as constituents of fatty-acid esters may be—without being restricted to these—alkanols, cycloalkanols and/or polyether alcohols. Examples are n-hexanol, n-dodecanol, n-octadecanol, cyclohexanol, 1,4-dihydroxycyclohexane, 1,3-propanediol, 2-methylpropanediol-1,3,1,5-pentanediol, 1,6-hexanediol, 1,8-octanediol, neopentyl glycol, diethylene glycol, triethylene glycol, tetraethylene glycol, dipropylene glycol, tripropylene glycol, dibutylene glycol, tripropylene glycol, glycerin and/or trimethylolpropane. Preferred in this connection are 1,3-propanediol, 1,5-pentanediol, 1,6-hexanediol, neopentyl glycol, diethylene glycol, triethylene glycol, and/or trimethylolpropane. The named alcohols exhibit boiling-points at which a discharge together with reaction water can be avoided, and at the customary reaction temperatures also do not have a tendency towards undesirable side reactions.

The process according to the invention is particularly well suited to convert fatty-acid esters without OH groups in the fatty-acid residues, such as, for example, fatty-acid esters on the basis of lauric acid, myristic acid, palmitic acid, stearic acid, palmitoleic acid, oleic acid, erucic acid, linoleic acid, linolenic acid, eleostearic acid or arachidonic acid or mixtures thereof, into the desired polyether ester polyols. Particularly preferably employed as fatty-acid esters A2) are triglycerides that are based on myristic acid, palmitic acid, palmitoleic acid, stearic acid, oleic acid, erucic acid, linoleic acid, linolenic acid, claidic acid and arachidonic acid; most preferably employed as fatty-acid ester A2) is soya oil.

As basic catalysts, use may be made of alkali-metal hydroxides, alkali-metal and alkaline-earth-metal hydrides, alkali-metal and alkaline-earth-metal carboxylates or alkaline-earth-metal hydroxides. Alkali metals are selected from the group consisting of Li, Na, K, Rb, Cs, and the alkaline-earth metals are selected from the group consisting of Be, Ca, Mg, Sr, Ba. Among these catalysts the alkali-metal compounds are preferred; particularly preferred are the alkali-metal hydroxides; quite particularly preferred is potassium hydroxide. Such an alkali-metal-containing catalyst can be supplied to the H-functional starter compound as aqueous solution or as solid matter. Likewise, organic basic catalysts such as, for example, amines may be employed. These encompass aliphatic amines or alkanolamines such as N,N-dimethylbenzylamine, dimethylaminoethanol, dimethylaminopropanol, N-methyldiethanolamine, trimethylamine, triethylamine, N,N-dimethylcyclohexylamine, N-ethylpyrrolidine, N,N,N′,N′-tetramethylethylenediamine, diazabicyclo[2,2,2]octane, 1,4-dimethylpiperazine or N-methylmorpholine. Also usable are aromatic amines such as imidazole and alkyl-substituted imidazole derivatives, N,N-dimethylaniline, 4-(N,N-dimethyl)aminopyridine and also partially cross-linked copolymers formed from 4-vinylpyridine or vinylimidazole and divinylbenzene. A comprehensive overview of catalytically active amines has been given by M. Ionescu et al. in ‘Advances in Urethanes Science and Technology’, 1998, 14, 151-218. The catalyst concentration, relative to the quantity of component A) obtained in step i), amounts to 40 ppm to 5000 ppm, preferably 40 ppm to 1000 ppm, particularly preferably 40 ppm to 700 ppm. The solvent water and/or the water released in the course of the reaction of the H-functional starter compounds with the catalyst can be removed before the start of the metering of one or more alkylene oxides or before the addition of one or more fatty-acid esters in a vacuum at an absolute pressure from 1 mbar to 500 mbar at temperatures from 20° C. to 200° C., preferably at 80° C. to 180° C.

As basic catalysts, prefabricated alkylene-oxide addition products of H-functional starter compounds with alkoxylate contents from 0.05 equivalence % to 50 equivalence % may also be employed, so-called ‘polymeric alkoxylates’. By the alkoxylate content of the catalyst, the proportion of active hydrogen atoms removed by a base, ordinarily an alkali-metal hydroxide, by deprotonation with respect to all the active hydrogen atoms that had originally been present in the alkylene-oxide addition product of the catalyst is to be understood. The dosage of the polymeric alkoxylates is, of course, dependent upon the catalyst concentration being striven for in respect of component A) obtained in step (i), as described in the preceding section.

The polymeric alkoxylate employed as catalyst may be produced in a separate reaction step by alkali-catalysed addition of alkylene oxides onto suitable H-functional starter compounds. For example, in the course of production of the polymeric alkoxylate an alkali-metal or alkaline-earth-metal hydroxide, for example KOH, is employed as catalyst in quantities from 0.1 wt. % to 1 wt. %, relative to the quantity of polymeric alkoxylate to be produced, the reaction mixture is dehydrated at an absolute pressure from 1 mbar to 500 mbar at temperatures from 20° C. to 200° C., preferably at 80° C. to 180° C., the alkylene-oxide addition reaction is carried out under inert-gas atmosphere at 100° C. to 150° C. until an OH value from 150 mg to 1200 mg KOH/g has been attained and then, by addition of further alkali-metal or alkaline-earth-metal hydroxide and subsequent dehydration, set to the alkoxylate contents stated above, from 0.05 equivalence % to 50 equivalence %. Polymeric alkoxylates produced in such a way can be stored separately under inert-gas atmosphere. They have already for a long time found application in the production of long-chain polyether polyols. The quantity of the polymeric alkoxylate employed in the process according to the invention is ordinarily such that it corresponds to a quantity of alkali-metal or alkaline-earth-metal hydroxide, relative to the mass of component A) obtained in step (i), from 40 ppm to 0.5 wt. %. The polymeric alkoxylates may also be employed in the process as mixtures.

The production of the polymeric alkoxylate may also be carried out in situ directly before the actual implementation of the process according to the invention in the same reactor. In this case the quantity of polymeric alkoxylate in the reactor that is necessary for a polymerisation charge is produced in accordance with the procedure described in the preceding paragraph. With this procedure, the quantity of H-functional starter compound at the beginning of the reaction should be such that said compound can also be stirred and the heat of reaction can be dissipated. This can optionally be obtained through the addition of inert solvents such as toluene and/or THF into the reactor in case the quantity of H-functional starter compound is too small for this.

H-functional starter compounds A1) are compounds that contain at least one hydrogen atom bonded to N, O or S. These hydrogen atoms are also designated as Tserevitinov-active hydrogen (sometimes also only as ‘active hydrogen’) if said hydrogen yields methane by a process discovered by Tserevitinov as a result of conversion with methylmagnesium iodide. Typical examples of compounds with Tserevitinov-active hydrogen are compounds that contain carboxyl, hydroxyl, amino, imino or thiol groups as functional groups.

Suitable H-functional starter compounds A1) mostly exhibit functionalities from 1 to 35, preferably from 1 to 8. Their molar masses amount to from 17 g/mol to 1200 g/mol. Besides the hydroxy-functional starters that are preferably to be used, amino-functional starters may also be employed. Examples of hydroxy-functional starter compounds are methanol, ethanol, 1-propanol, 2-propanol and higher aliphatic monols, in particular fatty alcohols, phenol, alkyl-substituted phenols, propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerin, trimethylolpropane, pentaerythritol, sorbitol, sucrose, hydroquinone, pyrocatechol, resorcinol, bisphenol F, bisphenol A, 1,3,5-trrihydroxybenzene, and also methylol-group-containing condensates formed from formaldehyde and phenol or urea. Highly functional starter compounds based on hydrated starch-hydrolysis products may also be employed. Such compounds are described, for example, in EP-A 1 525 244. Examples of suitable amino-group-containing H-functional starter compounds are ammonia, ethanolamine, diethanolamine, triethanolamine, isopropanolamine, diisopropanolamine, ethylenediamine, hexamethylenediamine, cyclohexylamine, diaminocyclohexane, isophoronediamine, the isomers of 1,8-p-diaminomethane, aniline, the isomers of toluidine, the isomers of diaminotoluene, the isomers of diaminodiphenylmethane and also higher-nuclear products arising in the course of the condensation of aniline with formaldehyde to form diaminodiphenylmethane, furthermore methylol-group-containing condensates formed from formaldehyde and melamine and also Mannich bases. In addition, ring-opening products formed from cyclic carboxylic acid anhydrides and polyols may also be employed as starter compounds. Examples are ring-opening products formed from phthalic acid anhydride, succinic acid anhydride, maleic acid anhydride, on the one hand, and ethylene glycol, diethylene glycol, 1,2-butanediol, 1,3-butanediol, 1,4-butanediol, hexanediol, pentanediol, 3-methyl-1,5-pentanediol, 1,12-dodecanediol, glycerin, trimethylolpropane, pentaerythritol or sorbitol, on the other hand.

Besides these, it is also possible to employ monofunctional or multifunctional carboxylic acids directly as starter compounds.

Furthermore, prefabricated alkylene-oxide addition products of the aforementioned starter compounds, that is to say, polyether polyols preferentially with OH values from 160 mg to 1000 mg KOH/g, preferably 250 mg to 1000 mg KOH/g, may also be added to the process. It is also possible to employ polyester polyols preferentially with OH values within the range from 6 mg to 800 mg KOH/g as co-starters in the process according to the invention with the aim of producing polyether esters. Suitable polyester polyols for this may, for example, be produced from organic dicarboxylic acids with 2 to 12 carbon atoms and from polyhydric alcohols, preferentially diols, with 2 to 12 carbon atoms, preferentially 2 to 6 carbon atoms, by known processes.

Moreover, by way of H-functional starter compounds A1) polycarbonate polyols, polyester carbonate polyols or polyether carbonate polyols, preferably polycarbonate diols, polyester carbonate diols or polyether carbonate diols, preferentially in each instance with OH values within the range from 6 mg to 800 mg KOH/g, may be used as co-starters. These are produced, for example, by conversion of phosgene, dimethyl carbonate, diethyl carbonate or diphenyl carbonate with difunctional or higher-functional alcohols or polyester polyols or polyether polyols.

In the process according to the invention preferably amino-group-free H-functional starter compounds with hydroxy groups serve as carriers of the active hydrogens, such as, for example, methanol, ethanol, 1-propanol, 2-propanol and higher aliphatic monols, in particular fatty alcohols, phenol, alkyl-substituted phenols, propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerin, trimethylolpropane, pentaerythritol, sorbitol, sucrose, hydroquinone, pyrocatechol, resorcinol, bisphenol F, bisphenol A, 1,3,5-trihydroxybenzene, methylol-group-containing condensates formed from formaldehyde and phenol, and hydrated starch-hydrolysis products. Among these, once again starter compounds with functionalities greater than or equal to four are preferred, such as, for example, pentaerythritol, sorbitol and sucrose. Mixtures of these starter compounds may also be employed.

The H-functional starter compounds A1) submitted together with the catalyst in the reactor and one or more fatty-acid esters A2) are caused to react in step (i-1) under inert-gas atmosphere at temperatures from 80° C. to 180° C., preferably at 100° C. to 170° C., with one or more alkylene oxides A3), the alkylene oxides being supplied in the common manner to the reactor continuously in such a manner that the safety pressure limits of the reactor system being used are not exceeded. Particularly in the course of the metering of ethylene-oxide-containing alkylene-oxide mixtures or pure ethylene oxide, care is to be taken to ensure that a sufficient partial pressure of inert gas is maintained in the reactor during the start-up and metering phases. This pressure can be adjusted, for example, by means of noble gases or nitrogen. The reaction temperature can, of course, be varied during the alkylene-oxide metering phase within the described limits: it is advantageous to alkoxylate sensitive l-functional starter compounds, such as, for example, sucrose, firstly at low reaction temperatures, and only in the case of sufficient conversion of the starter to proceed to higher reaction temperatures. Alkylene oxides can be supplied to the reactor in varying ways: possible is a metering into the gas phase or directly into the liquid phase, for example via an immersion pipe or a ring manifold located in the vicinity of the bottom of the reactor in a well intermixed zone. In the case of metering into the liquid phase, the metering units should have been designed to be self-emptying, for example by fitting the metering bores to the underside of the ring manifold. Generally, a return flow of reaction medium into the metering units should be prevented by instrumental measures, for example by the installation of check valves. If an alkylene-oxide mixture is being metered, the respective alkylene oxides can be supplied to the reactor separately or as a mixture. A premixing of the alkylene oxides may, for example, be obtained by means of a mixing unit located in the common metering section (‘inline blending’). It has also proved worthwhile to meter alkylene oxides, individually or premixed, on the pump-discharge side into a recirculating circuit which is conducted, for example, via heat-exchangers. For the good intermixing with the reaction medium it is then advantageous to integrate a high-shearing mixing unit into the stream of alkylene oxide and reaction medium. The temperature of the exothermic alkylene-oxide addition reaction is maintained at the desired level by cooling. According to the state of the art relating to the design of polymerisation reactors for exothermic reactions (for example Ullmann's Encyclopedia of Industrial Chemistry, Vol. B4, pp 167ff, 5th ed., 1992), such a cooling is generally effected across the reactor wall (for example, double-walled jacket, semi-tubular coil) and also by means of further heat-exchanger surfaces arranged internally in the reactor and/or externally in the recirculating circuit, for example on cooling coils, cooling bars, plate-type heat-exchangers, shell-and-tube heat-exchangers or mixer-type heat-exchangers. These should be designed in such a way that cooling can take place effectively also at the beginning of the metering phase, i.e. with a low filling level.

Generally, in all the reaction phases a good intermixing of the contents of the reactor should be provided for by design and use of commercially available stirring elements, whereby here, in particular, stirrers arranged in one stage or in multiple stages or types of stirrer acting over a large area over the filling height are suitable (see, for example, Handbuch Apparate; Vulkan-Verlag Essen, 1. Ed. (1990), pp 188-208). Technically particularly relevant in this connection is a mixing energy, input on average via the entire contents of the reactor, that generally lies within the range from 0.2 W/l to 5 W/l, with correspondingly higher local power inputs in the region of the stirring elements themselves and optionally at lower filling levels. In order to achieve an optimal stirring action, in accordance with the general state of the art combinations of baffles (for example, flat or tubular baffles) and cooling coils (or cooling bars) may be arranged in the reactor, which may also extend over the bottom of the container. The stirring power of the mixing unit can also be varied during the metering phase in filling-level-dependent manner, in order to guarantee a particularly high energy input in critical reaction phases. For example, it can be advantageous to intermix solids-bearing dispersions, which may be present at the start of the reaction, for example with the use of sucrose, particularly intensively. In addition, particularly with the use of solid H-functional starter compounds it should be ensured through the choice of the stirring unit that a sufficient dispersion of the solid matter in the reaction mixture is guaranteed. Preferably bottom-sweeping stirring stages and also stirring elements that are particularly suitable for suspension are employed here. Furthermore, the geometry of the stirrer should contribute to diminishing the foaming of reaction products. The foaming of reaction mixtures can, for example, be observed after the end of the metering and secondary-reaction phases when residual alkylene oxides are being additionally removed in a vacuum at absolute pressures within the range from 1 mbar to 500 mbar. For such cases, stirring elements have proved suitable that achieve a continuous intermixing of the surface of the liquid. Depending on the requirement, the stirrer shaft exhibits a bottom bearing and optionally further support bearings in the container. The drive of the stirrer shaft may in this case be effected from above or from below (with centric or eccentric arrangement of the shaft).

Alternatively it is also possible to achieve the necessary intermixing exclusively via a recirculating circuit conducted via a heat-exchanger, or to operate said circuit as a further mixing component in addition to the stirring unit, whereby the contents of the reactor are recirculated as needed (typically 1 to 50 times an hour).

The most diverse types of reactor are suitable for the implementation of the process according to the invention. Preferentially, cylindrical containers are employed that have a height/diameter ratio from 1:1 to 10:1. By way of reactor bottoms, spherical, torispherical, flat or conical bottoms enter into consideration, for example.

In a preferred embodiment of the process according to the invention, in step (i-1) firstly 5 wt. % to 95 wt. % of the quantity of one or more alkylene oxides A3) to be supplied overall in step (i-1) are converted with an H-functional starter compound A1), are subsequently mixed with one or more fatty-acid esters A2), and then 95 wt. % to 5 wt. % of the quantity of alkylene oxide A3) to be supplied overall in step (i-1) are added in metered amounts, or in step (i-1) firstly 5 wt. % to 95 wt. % of the quantity of one or more alkylene oxides A3) to be supplied overall in step (i-1) are converted with an H-functional starter compound A1) and subsequently together with one or more fatty-acid esters A2) and 95 wt. % to 5 wt. % of the quantity of alkylene oxide A3) to be supplied overall in step (i-1) are added in metered amounts and caused to react.

By the alkylene oxides A3), alkylene oxides (epoxides) with 2-24 carbon atoms are to be understood. These may also be employed in step (ii) as alkylene oxides B1). It is a question, for example, of one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, singly-epoxidised or multiply-epoxidised fats as monoglycerides, diglycerides and triglycerides, epoxidised fatty acids, C₁-C₂₄ esters of epoxidised fatty acids, epichlorohydrin, glycidol, and derivatives of glycidol, such as, for example, methylglycidyl ether, ethylglycidyl ether, 2-ethylhexyiglycidyl ether, allylglycidyl ether, glycidyl methacrylate, and also epoxide-functional alkyloxysilanes such as, for example, 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane.

As alkylene oxides A3), preferably ethylene oxide and/or propylene oxide, preferably at least 10% ethylene oxide and, quite particularly preferably, pure ethylene oxide, are employed.

If the alkylene oxides are metered in succession, the products that are produced contain polyether chains with block structures. After the end of the alkylene-oxide metering phase a secondary-reaction phase may follow directly, in which residual alkylene oxide reacts off. The end of this secondary-reaction phase is attained when no further drop in pressure in the reaction vessel can be established. After the reaction phase, traces of unreacted epoxides can optionally be removed in a vacuum at an absolute pressure from 1 mbar to 500 mbar.

(i-2)

The neutralisation of the alkaline, polymerisation-active centres of the crude alkylene-oxide addition product from step (i-1) is effected, in accordance with the invention, in step (i-2) by addition of sulfuric acid in such a manner that from 66 mol % to 100 mol % of the acid employed only the first dissociation stage becomes active for the purpose of neutralising the quantity of catalyst contained in the crude polymerisate. This can, for example, be achieved by at least 50% more sulfuric acid being employed than would be necessary for neutralising the basic catalyst. Since the 2nd dissociation stage of the sulfuric acid also possesses a sufficient pKa, in the process according to the invention use is made of 0.75 mol to 1 mol sulfuric acid per mol catalyst to be neutralised, preferentially 0.75 mol to 0.9 mol sulfuric acid per mol catalyst to be neutralised. Although the temperature can be varied within wide ranges in the course of the neutralisation, it is advisable not to exceed temperatures of maximally 100° C., preferably 80° C., particularly preferably 60° C. and quite particularly preferably 40° C., in the course of the neutralisation, since hydrolysis-sensitive ester groups are present in the products.

(i-3)

After neutralisation has been effected, traces of water, which, for example, were introduced by addition of dilute acids, can optionally be removed in a vacuum at an absolute pressure from 1 mbar to 500 mbar (step (i-3)). To component A) obtained in this way, during or after the neutralisation anti-ageing agents or anti-oxidants can be added as needed. The salts formed in the course of the neutralisation remain in component A); that is to say, further reprocessing steps, such as, for example, filtration, are not necessary. Component A) exhibits an OH value of at least 70 mg KOH/g, preferably from 130 mg to 500 mg KOH/g, and particularly preferably from 180 mg to 300 mg KOH/g.

### Step (ii):

To component A) obtained from step (i), in step (ii) in one embodiment of the process according to the invention the DMC catalyst B2) is added and converted with one or more alkylene oxides B1) until polyether ester polyols (1) with an OH value from 3 mg to less than the OH value of component A), preferably from 3 mg to 120 mg KOH/g, particularly preferably from 14 mg to 75 mg KOH/g, are obtained. Before addition of the DMC catalyst, in addition small quantities (1 ppm to 500 ppm) of other organic or inorganic acids can be added to component A), as described in WO 99/14258. The conversion of component A) in step (ii) with one or more alkylene oxides B1) under DMC catalysis can, in principle, be effected in the same reactor as the production of component A) in step (i). The DMC catalyst concentration calculated in respect of the quantity of end product (1) lies within the range from 10 ppm to 1000 ppm.

DMC catalysts B2) are, in principle, known from the state of the art (see, for example, U.S. Pat. No. 3,404,109, U.S. Pat. No. 3,829,505, U.S. Pat. No. 3,941,849 and U.S. Pat. No. 5,158,922). DMC catalysts, which, for example, are described in U.S. Pat. No. 5,470,813, EP-A 700 949, EP-A 743 093, EP-A 761 708, WO 97/40086, WO 98/16310 and WO 00/47649, possess a very high activity in the polymerisation of epoxides and enable the production of polyether polyols at very low catalyst concentrations (25 ppm or less), so that a separation of the catalyst from the finished product is generally no longer necessary. A typical example is constituted by the highly active DMC catalysts described in EP-A 700 949, which besides a double-metal-cyanide compound (for example, zinc hexacyanocobaltate(III)) and an organic complex ligand (for example, tert.-butanol) also contain a polyether with a number-average molecular weight greater than 500 g/mol.

It is also possible to employ the alkaline DMC catalysts disclosed in EP application number 10163170.3.

Cyanide-free metal salts that are suitable for producing the double-metal-cyanide compounds preferably have the general formula (I),

M(X)ₙ (I)

wherein

M is selected from the metal cations Zn²⁺, Fe²⁺, Ni²⁺, Mn²⁺, Co²⁺, Sr²⁺, Sn²⁺, Pb²⁺ and, Cu²⁺; M is preferably Zn²⁺, Fe²⁺, Co²⁺ or Ni²⁺,

X are one or more (i.e. various) anions, preferentially an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

n is 1 if X=sulfate, carbonate or oxalate and

n is 2 if X=halide, hydroxide, cyanate, thiocyanate, isocyanate, isothiocyanate or nitrate,

or suitable cyanide-free metal salts have the general formula (II),

Mᵣ(X)₃ (II)

wherein

M is selected from the metal cations Fe³⁺, Al³⁺ and Cr³⁺,

X are one or more (i.e. various) anions, preferentially an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

r is 2 if X=sulfate, carbonate or oxalate and

r is 1 if X=halide, hydroxide, cyanate, thiocyanate, isocyanate, isothiocyanate, carboxylate or nitrate,

or suitable cyanide-free metal salts have the general formula (III),

M(X)ₛ (III)

wherein

M is selected from the metal cations Mo⁴⁺, V⁴⁺ and W⁴⁺

X are one or more (i.e. various) anions, preferentially an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

s is 2 if X=sulfate, carbonate or oxalate and

s is 4 if X=halide, hydroxide, cyanate, thiocyanate, isocyanate, isothiocyanate, carboxylate or nitrate,

or suitable cyanide-free metal salts have the general formula (IV),

M(X)ₜ (IV)

wherein

M is selected from the metal cations Mo⁶⁺ and W⁶⁺

X are one or more (i.e. various) anions, preferentially an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

t is 3 if X=sulfate, carbonate or oxalate and

t is 6 if X=halide, hydroxide, cyanate, thiocyanate, isocyanate, isothiocyanate, carboxylate or nitrate.

Examples of suitable cyanide-free metal salts are zinc chloride, zinc bromide, zinc iodide, zinc acetate, zinc acetylacetonate, zinc benzoate, zinc nitrate, iron(II) sulfate, iron(II) bromide, iron(II) chloride, cobalt(II) chloride, cobalt(II) thiocyanate, nickel(II) chloride and nickel(II) nitrate. Mixtures of various metal salts may also be employed.

Metal-cyanide salts that are suitable for producing the double-metal-cyanide compounds preferably have the general formula (V)

(Y)ₐM′(CN)_{b}(A)_{c} (V)

wherein

M′ is selected from one or more metal cations of the group consisting of Fe(II), Fe(III), Co(II), Co(II), Cr(II), Cr(III), Mn(II), Mn(III), Ir(III), Ni(I), Rh(III), Ru(II), V(IV) and V(V), M′ is preferably one or more metal cations of the group consisting of Co(II), Co(III), Fe(II), Fe(III), Cr(III), Ir(III) and Ni(II),

Y is selected from one or more metal cations of the group consisting of alkali metals (i.e. Li⁺, Na⁺, K⁺, Rb⁺, Cs⁺) and alkaline-earth metals (i.e. Be²⁺, Ca²⁺, Mg²⁺, Sr²⁺, Ba²⁺),

A is selected from one or more anions of the group consisting of halides (i.e. fluoride, chloride, bromide, iodide), hydroxide, sulfate, carbonate, cyanate, thiocyanate, isocyanate, isothiocyanate, carboxylate, oxalate or nitrate and

a, b and c are integers, the values for a, b and c being chosen in such a way that the electroneutrality of the metal-cyanide salt obtains; a is preferentially 1, 2, 3 or 4; b is preferentially 4, 5 or 6; c preferably has the value 0.

Examples of suitable metal-cyanide salts are potassium hexacyanocobaltate(III), potassium hexacyanoferrate(II), potassium hexacyanoferrate(III), calcium hexacyanocobaltate(II) and lithium hexacyanocobaltate(III).

Preferred double-metal-cyanide compounds that are contained in the DMC catalysts according to the invention are compounds of the general formula (VI)

Mₓ[M′_{x′}(CN)_{y}]_{z} (VI)

in which M is defined as in formulae (I) to (IV) and

M′ is defined as in formula (V), and

x, x′, y and z are integral and are chosen in such a way that the electroneutrality of the double-metal-cyanide compound obtains.

Preferentially,

x=3, x′=1, y=6 and z=2,

M=Zn(II), Fe(II), Co(II) or Ni(II) and

M′=Co(III), Fe(III), Cr(III) or Ir(II).

Examples of suitable double-metal-cyanide compounds are zinc hexacyano-cobaltate(III), zinc hexacyanoiridate(III), zinc hexacyanoferrate(III) and cobalt(II)hexacyanocobaltate(III). Further examples of suitable double-metal-cyanide compounds can be gathered from, for example, U.S. Pat. No. 5,158,922 (column 8, lines 29-66). Particularly preferably, use is made of zinc hexacyanocobaltate(III).

The organic complex ligands added in the course of production of the DMC catalysts are disclosed, for example, in U.S. Pat. No. 5,158,922 (see, in particular, column 6, lines 9 to 65), U.S. Pat. No. 3,404,109, U.S. Pat. No. 3,829,505, U.S. Pat. No. 3,941,849, EP-A 700 949, EP-A 761 708, JP-A 4145123, U.S. Pat. No. 5,470,813, EP-A 743 093 and WO-A 97/40086). For example, water-soluble, organic compounds with heteroatoms, such as oxygen, nitrogen, phosphorus or sulfur, which may form complexes with the double-metal-cyanide compound, are employed as organic complex ligands. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, iso-butanol, sec.-butanol, tert-butanol, 2-methyl-3-buten-2-ol and 2-methyl-3-butin-2-ol), compounds that contain both aliphatic or cycloaliphatic ether groups and also aliphatic hydroxyl groups (such as, for example, ethylene glycol mono-tert.-butyl ether, diethylene glycol mono-tert.-butyl ether, tripropylene glycol monomethyl ether and 3-methyl-3-oxetanemethanol). Highly preferred organic complex ligands are selected from one or more compounds of the group consisting of dimethoxyethane, tert-butanol, 2-methyl-3-buten-2-ol, 2-methyl-3-butin-2-ol, ethylene glycol mono-tert.-butyl ether and 3-methyl-3-oxetanemethanol.

In the course of production of the DMC catalysts according to the invention one or more complex-forming components from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylene imines, maleic-acid and maleic-acid-anhydride copolymers, hydroxyethylcellulose and polyacetals, or of the glycidyl ethers, glycosides, carboxylic acid esters of polyhydric alcohols, bile acids or the salts, esters or amides thereof, cyclodextrins, phosphorus compounds, α,β-unsaturated carboxylic acid esters or ionic surface-active or interface-active compounds are optionally employed.

Preferably, in the course of production of the DMC catalysts according to the invention in the first step the aqueous solutions of the metal salt (for example, zinc chloride), employed in stoichiometric excess (at least 50 mol %) relative to metal-cyanide salt (that is to say, at least a molar ratio of cyanide-free metal salt to metal-cyanide salt from 2.25 to 1.00), and of the metal-cyanide salt (for example, potassium hexacyanocobaltate) are converted in the presence of the organic complex ligand (for example, tert.-butanol), so that a suspension forms that contains the double-metal-cyanide compound (for example, zinc hexacyanocobaltate), water, excess cyanide-free metal salt and the organic complex ligand. The organic complex ligand may in this case be present in the aqueous solution of the cyanide-free metal salt and/or of the metal-cyanide salt, or it is added immediately to the suspension obtained after precipitation of the double-metal-cyanide compound. It has proved advantageous to mix the aqueous solutions of the cyanide-free metal salt and of the metal-cyanide salt and the organic complex ligand with vigorous stirring. The suspension formed in the first step is optionally treated subsequently with a further complex-forming component. The complex-forming component is preferably employed in this case in a mixture with water and with organic complex ligand. A preferred process for implementing the first step (i.e. the production of the suspension) is effected by using a mixing nozzle, particularly preferably by using a jet disperser as described in WO-A 01/39883.

In the second step the isolation of the solid matter (i.e. the precursor of the catalyst according to the invention) from the suspension is effected by known techniques such as centrifugation or filtration.

In a preferred embodiment variant for producing the catalyst the isolated solid matter is subsequently washed in a third process step with an aqueous solution of the organic complex ligand (for example, by re-suspension and subsequent renewed isolation by filtration or centrifugation). In this way, for example, water-soluble by-products such as potassium chloride can be removed from the catalyst according to the invention. Preferably the quantity of the organic complex ligand in the aqueous washing solution lies between 40 wt. % and 80 wt. %, relative to the overall solution.

In the third step of the aqueous washing solution a further complex-forming component, preferably within the range between 0.5 wt. % and 5 wt. %, relative to the overall solution, is optionally added.

In addition, it is advantageous to wash the isolated solid matter more than once. For this purpose, for example, the first washing operation may be repeated. But it is preferred to use non-aqueous solutions, for example a mixture of organic complex ligand and further complex-forming component, for further washing operations.

The isolated and optionally washed solid matter is subsequently dried, optionally after pulverisation, at temperatures from generally 20° C. to 100° C. and at pressures from generally 0.1 mbar to normal pressure (1013 mbar).

A preferred process for isolating the DMC catalysts according to the invention from the suspension by filtration, filter-cake washing and drying is described in WO-A 01/80994.

The DMC-catalysed reaction step (ii) can generally be carried out in accordance with the same processing principles as the production of component A) effected under basic catalysis in step (i). In particular, the same alkylene oxides or alkylene-oxide mixtures can be used; that is to say, the compounds listed as alkylene oxides A3) can also be employed in step (ii) as alkylene oxides BI). Some processing particulars of the DMC-catalysed reaction step (ii) will be discussed in the following.

In one embodiment, component A) is mixed with DMC catalyst. After heating to temperatures from 60° C. to 160° C., preferably 100° C. to 140° C., quite particularly preferably 120° C. to 140° C., in a preferred process variant the contents of the reactor are stripped with inert gas over a period of preferably 10 min to 60 min, with stirring. In the course of the stripping with inert gas, volatile constituents are removed by introducing inert gases into the liquid phase with simultaneously applied vacuum at an absolute pressure from 5 mbar to 500 mbar. After metering-in of, typically, 5 wt. % to 20 wt. % of one or more alkylene oxides BI), relative to the quantity of component A) submitted in step (ii), the DMC catalyst is activated. The addition of one or more alkylene oxides can happen before, during or after the heating of the contents of the reactor to temperatures from 60° C. to 160° C., preferably 100° C. to 140° C., quite particularly preferably 120° C. to 140° C.; it is preferably effected after the stripping. The activation of the catalyst becomes noticeable through an accelerated drop in the pressure of the reactor, by which the incipient conversion of alkylene oxide is indicated. To the reaction mixture the desired quantity of alkylene oxide or alkylene-oxide mixture can then be continuously supplied, whereby a reaction temperature is chosen from 20° C. to 200° C., but preferably from 50° C. to 160° C. In most cases the reaction temperature is identical with the activation temperature. Often the activation of the catalyst is already effected so quickly that the metering of a separate quantity of alkylene oxide for the purpose of activating the catalyst can be dispensed with and, optionally firstly at a reduced metering-rate, the continuous metering of one or more alkylene oxides can be begun directly. Also in the DMC-catalysed reaction step the reaction temperature during the alkylene-oxide metering phase can be varied within the described limits. Likewise, one or more alkylene oxides can be supplied to the reactor in varying ways in the DMC-catalysed reaction step: possible is a metering into the gas phase or directly into the liquid phase, for example via an immersion pipe or a ring manifold located in the vicinity of the bottom of the reactor in a well intermixed zone. In the case of DMC-catalysed processes, metering into the liquid phase is the preferred variant.

After the end of the metering of alkylene oxide a secondary-reaction phase may follow directly, in which the decrease of the concentration of unreacted alkylene oxide can be quantified by monitoring the pressure. After the end of the secondary-reaction phase the reaction mixture can optionally be quantitatively freed from small quantities of unconverted alkylene oxides, for example in a vacuum at an absolute pressure from 1 mbar to 500 mbar or by stripping. As a result of stripping, volatile constituents, such as, for example, (residual) alkylene oxides, are removed by introducing inert gases or water vapour into the liquid phase with simultaneously applied vacuum at an absolute pressure from 5 mbar to 500 mbar. The removal of volatile constituents, such as, for example, unconverted alkylene oxides, either in a vacuum or by stripping is effected at temperatures from 20° C. to 200° C., preferably at 50° C. to 160° C., and preferentially with stirring. Such stripping operations can also be carried out in so-called stripping columns in which a stream of inert gas or water vapour is conducted towards the stream of product. After constancy of pressure has been attained or after volatile constituents have be removed by vacuum and/or stripping, the product can be discharged from the reactor.

The OH value of the end product (1) amounts to from 3 mg KOH/g to less than the OH value of component A), preferably from 3 mg to 120 mg KOH/g, particularly preferably from 14 mg to 75 mg KOH/g.

In a further embodiment of the process according to the invention, in step (ii) a starter polyol and the DMC catalyst are submitted in the reactor system and component A) is supplied continuously together with one or more alkylene oxides BI). Suitable as starter polyol in step (ii) are alkylene-oxide addition products, such as, for example, polyether polyols, polycarbonate polyols, polyester carbonate polyols, polyether carbonate polyols, in each instance, for example, with OH values within the range from 3 mg to 1000 mg KOH/g, preferentially from 3 mg to 300 mg KOH/g, a partial quantity of component A), and/or end product (1) according to the invention that was previously produced separately. Preferentially, a partial quantity of component A) or end product (1) according to the invention that was previously produced separately is employed as starter polyol in step (ii). Particularly preferably, end product (1) according to the invention that was previously produced separately is employed as starter polyol in step (ii).

Preferentially, the metering of component A) and that of one or more alkylene oxides are concluded simultaneously, or component A) and a first partial quantity of one or more alkylene oxides BI) are firstly added together in metered amounts and subsequently the second partial quantity of one or more alkylene oxides B1) is added in metered amounts, whereby the sum of the first and second partial quantities of one or more alkylene oxides B1) corresponds to the total quantity of quantity of one or more alkylene oxides B1) employed in step (ii). The first partial quantity preferentially amounts to 60 wt. % to 98 wt. %, and the second partial quantity amounts to 40 wt. % to 2 wt. % of the quantity of one or more alkylene oxides BI) to be metered overall in step (ii). After addition of the reagents in metered amounts, a secondary-reaction phase may follow directly, in which the consumption of alkylene oxide can be quantified by monitoring the pressure. After constancy of pressure has been attained, the end product, optionally after applying vacuum or by stripping for the purpose of removing unconverted alkylene oxides, as described above, can be discharged.

It is also possible in step (ii) to submit the entire quantity of component A) and DMC catalyst and to supply continuously one or more H-functional starter compounds, in particular those with equivalent molar masses, for example, within the range from 30.0 Da to 350 Da, together with one or more alkylene oxides BI).

By ‘equivalent molar mass’ the total mass of the material containing Tserevitinov-active hydrogen atoms divided by the number of Tserevitinov-active hydrogen atoms is to be understood. In the case of hydroxyl-group-containing materials it is calculated by the following formula:

equivalent molar mass=56100/OH value [mg KOH/g]

The OH value can, for example, be determined titrimetrically in accordance with the directions of DIN 53240, or spectroscopically via NIR.

In a further embodiment of the process according to the invention the reaction product (1) is withdrawn continuously from the reactor. In this processing mode, in step (ii) a starter polyol and a partial quantity of DMC catalyst are submitted in the reactor system, and component A) is supplied continuously together with one or more alkylene oxides BI) and DMC catalyst, and the reaction product (1) is withdrawn continuously from the reactor. Suitable as starter polyol in step (ii) are alkylene-oxide addition products, such as, for example, polyether polyols, polycarbonate polyols, polyester carbonate polyols, polyether carbonate polyols, in each instance, for example, with OH values within the range from 3 mg to 1000 mg KOH/g, preferentially from 3 mg to 300 mg KOH/g, a partial quantity of component A), and/or end product (1) according to the invention that was previously produced separately. Preferentially, a partial quantity of component A) or end product (1) according to the invention that was previously produced separately is employed as starter polyol in step (ii). Particularly preferably, end product (1) according to the invention that was previously produced separately is employed as starter polyol in step (ii).

In this case, continuous secondary-reaction steps, for example in a reactor cascade or in a tubular reactor, may follow directly. Volatile constituents can be removed in a vacuum and/or by stripping, as described above.

The various process variants in the course of production of polyether polyols by the alkylene-oxide addition processes under DMC-complex catalysis are described, for example, in WO-A 97/29146 and WO-A 98/03571.

Preferentially, the DMC catalyst remains in the end product, but it may also be separated off, for example by treatment with adsorbents. Processes for separating DMC catalysts are described, for example, in U.S. Pat. No. 4,987,271, DE-A 31 32 258, EP-A 406 440, U.S. Pat. No. 5,391,722, U.S. Pat. No. 5,099,075, U.S. Pat. No. 4,721,818, U.S. Pat. No. 4,877,906 and EP-A 385 619.

The polyether ester polyols (1) that are obtainable by the process according to the invention can be employed as initial components for the production of polyurethane formulations and of solid matter or foamed polyurethanes such as, for example, polyurethane elastomers, polyurethane flexible foams and polyurethane rigid foams. These polyurethanes may also contain isocyanurate structural units, allophanate structural units and biuret structural units.

Polyurethanes containing the polyether ester polyols (1) that are obtainable by the process according to the invention, in particular foamed polyurethanes such as, for example, polyurethane elastomers, polyurethane flexible foams and polyurethane rigid foams, are likewise a subject of the invention.

These polyurethanes are produced by conversion of

I) the polyether ester polyols (1) according to the invention,

II) optionally, further isocyanate-reactive compounds,

III) optionally, expanding agents,

IV) optionally, catalysts,

V) optionally, additives such as, for example, cell stabilisers

with organic polyisocyanates.

As further isocyanate-reactive compounds, component II), polyether polyols, polyester polyols, polycarbonate polyols, polyether carbonate polyols, polyester carbonate polyols, polyether carbonate polyols and/or chain-lengthening agents and/or cross-linking agents with OH values or NH values from 6 mg to 1870 mg KOH/g can optionally be admixed to the polyether ester polyols (1) according to the invention as component I) in polyurethane formulations.

Polyether polyols that are suitable for this may, for example, be obtained by anionic polymerisation of alkylene oxides in the presence of alkali hydroxides or alkali alcoholates as catalysts and with addition of at least one H-functional starter compound that contains 2 to 8 Tserevitinov-active hydrogen atoms in bonded form, or by cationic polymerisation of alkylene oxides in the presence of Lewis acids such as antimony pentachloride or borofluoride etherate. Suitable catalysts are also those of the double-metal-cyanide (DMC) type, such as are described, for example, in U.S. Pat. No. 3,404,109, U.S. Pat. No. 3,829,505, U.S. Pat. No. 3,941,849, U.S. Pat. No. 5,158,922, U.S. Pat. No. 5,470,813, EP-A 700 949, EP-A 743 093, EP-A 761 708, WO-A 97/40086, WO-A 98/16310 and WO-A 00/47649. Suitable alkylene oxides and also some suitable H-functional starter compounds have already been described in preceding sections. To be mentioned by way of supplement are tetrahydrofuran as Lewis-acid polymerisable cyclic ether and water as starter molecule. The polyether polyols, preferentially polyoxypropylene polyoxyethylene polyols, preferentially have number-average molar masses from 200 Da to 8000 Da. Suitable furthermore as polyether polyols are polymer-modified polyether polyols, preferentially graft polyether polyols, in particular those based on styrene and/or on acrylonitrile, which are produced by in situ polymerisation of acrylonitrile, styrene or, preferentially, mixtures of styrene and acrylonitrile, for example in a weight ratio from 90:10 to 10:90, preferentially 70:30 to 30:70, expediently in the aforementioned polyether polyols, and also polyether polyol dispersions that contain as disperse phase, ordinarily in a quantity from 1 wt. % to 50 wt. %, preferentially 2 wt. % to 25 wt. %, inorganic fillers, polyureas, polyhydrazides, polyurethanes containing tert. amino groups in bonded form, and/or melamine.

Suitable polyester polyols may, for example, be produced from organic dicarboxylic acids with 2 to 12 carbon atoms and polyhydric alcohols, preferentially diols, with 2 to 12 carbon atoms, preferentially 2 to 6 carbon atoms. By way of dicarboxylic acids there enter into consideration, for example: succinic acid, glutaric acid, adipic acid, suberic acid, azelaic acid, sebacic acid, decanedicarboxylic acid, dodecanedicarboxylic acid, maleic acid, fumaric acid, phthalic acid, isophthalic acid and terephthalic acid. The dicarboxylic acids can be used in this case both individually and in a mixture with one another. Instead of the free dicarboxylic acids, the corresponding dicarboxylic-acid derivatives, such as, for example, dicarboxylic acid monoesters and/or diesters of alcohols with 1 to 4 carbon atoms or dicarboxylic acid anhydrides can also be employed. Preferentially used are dicarboxylic-acid mixtures of succinic, glutaric and adipic acids in quantitative ratios of, for example, 20 to 35/40 to 60/20 to 36 parts by weight and, in particular, adipic acid. Examples of dihydric and polyhydric alcohols are ethanediol, diethylene glycol, 1,2- and 1,3-propanediol, dipropylene glycol, methyl-1,3-propanediol, 1,4-butanediol, 1,5-pentanediol, 3-methyl-1,5-pentanediol, 1,6-hexanediol, neopentyl glycol, 1,10-decanediol, 1,12-dodecanediol, glycerin, trimethylolpropane and pentaerythritol. Preferentially used are 1,2-ethanediol, diethylene glycol, 1,4-butanediol, 1,6-hexanediol, glycerin, trimethylolpropane or mixtures of at least two of the named polyhydric alcohols, in particular mixtures of ethanediol, 1,4-butanediol and 1,6-hexanediol, glycerin and/or trimethylolpropane. Polyester polyols formed from lactones, for example ε-caprolactone, or hydroxycarboxylic acids, for example hydroxycaproic acid and hydroxyacetic acid, may furthermore be employed.

For the purpose of producing the polyester polyols, the organic, aromatic or aliphatic polycarboxylic acids and/or polycarboxylic acid derivatives and polyhydric alcohols can be polycondensed in catalyst-free manner or in the presence of esterification catalysts, expediently in an atmosphere consisting of inert gases such as, for example, nitrogen, helium or argon and also in a melt at temperatures from 150° C. to 300° C., preferentially 180° C. to 230° C., optionally under reduced pressure up until the desired acid values and OH values. The acid value is advantageously less than 10, preferentially less than 2.5.

According to a preferred production process, the esterification mixture is polycondensed at the aforementioned temperatures up until an acid value from 80 to 30, preferentially 40 to 30, under normal pressure, and subsequently under a pressure of less than 500 mbar, preferentially 1 mbar to 150 mbar. By way of esterification catalysts, iron, cadmium, cobalt, lead, zinc, antimony, magnesium, titanium and tin catalysts in the form of metals, metal oxides or metal salts enter into consideration, for example. However, the polycondensation of aromatic or aliphatic carboxylic acids with polyhydric alcohols may also be carried out in liquid phase in the presence of diluents and/or entraining agents, such as, for example, benzene, toluene, xylene or chlorobenzene, with a view to azeotropic removal of the condensate water by distillation.

The ratio of dicarboxylic acid (derivative) and polyhydric alcohol to be chosen with a view to obtaining a desired OH value, functionality and viscosity, and the alcohol functionality to be chosen, can be ascertained in simple manner by a person skilled in the art.

Suitable polycarbonate polyols are those of the type known as such, which, for example, can be produced by conversion of diols such as 1,2-propanediol, 1,4-butanediol, 1,6-hexanediol, diethylene glycol, triethylene glycol, tetraethylene glycol oligotetramethylene glycol and/or oligohexamethylene glycol with diaryl carbonates and/or dialkyl carbonates, for example diphenyl carbonate, dimethyl carbonate and also α-ω-bischloroformates or phosgene.

Suitable polyether carbonate polyols are accessible, for example, by copolymerisation of carbon dioxide and alkylene oxides onto multifunctional hydroxy-group-containing starter compounds. Suitable catalysts for this are, in particular, catalysts of the DMC type as described above.

Difunctional chain-lengthening agents and/or preferentially trifunctional or tetrafunctional cross-linking agents can be admixed to the polyether ester polyols (1) to be employed in accordance with the invention for the purpose of modifying the mechanical properties, in particular the hardness, of the polyurethanes. Suitable chain-lengthening agents such as alkanediols, dialkylene glycols and polyalkylene polyols and cross-linking agents, for example trihydric or tetrahydric alcohols and oligomeric polyalkylene polyols with a functionality from 3 to 4, ordinarily have molecular weights of less than 800 Da, preferentially from 18 Da to 400 Da and in particular from 60 Da to 300 Da. Preferentially used as chain-lengthening agents are alkanediols with 2 to 12 carbon atoms, for example ethanediol, 1,3-propanediol, 1,5-pentanediol, 1,6-hexanediol, 1,7-heptanediol, 1,8-octanediol, 1,9-nonanediol, 1,10-decanediol and, in particular, 1,4-butanediol and dialkylene glycols with 4 to 8 carbon atoms, for example diethylene glycol and dipropylene glycol and also polyoxyalkylene glycols. Also suitable are branched-chain and/or unsaturated alkanediols with, ordinarily, no more than 12 carbon atoms, such as, for example, 1,2-propanediol, 2-methyl-1,3-propanediol, 3-methyl-1,5-pentanediol, 2,2-dimethyl-1,3-propanediol, 2-butyl-2-ethyl-1,3-propanediol, 2-butene-1,4-diol and 2-butane-1,4-diol, diesters of terephthalic acid with glycols with 2 to 4 carbon atoms, such as, for example, terephthalic acid bis(ethylene glycol ester) or terephthalic acid bis(1,4-butylene glycol ester) and hydroxyalkylene ethers of hydroquinone or of resorcinol, for example 1,4-di(3-hydroxyethyl)hydroquinone or 1,3-(P-hydroxyethyl)resorcinol. Alkanolamines with 2 to 12 carbon atoms, such as ethanolamine, 2-aminopropanol and 3-amino-2,2-dimethylpropanol, N-alkyldialkanolamines, for example N-methyl and N-ethyl diethanolamine, (cyclo)aliphatic diamines with 2 to 15 carbon atoms, such as 1,2-ethylenediamine, 1,3-propylenediamine, 1,4-butylenediamine and 1,6-hexamethylenediamine, isophoronediamine, 1,4-cyclohexamethylenediamine and 4,4′-diaminodicyclohexylmethane, N-alkyl-substituted, N,N′-dialkyl-substituted and aromatic diamines, which also may be substituted on the aromatic residue by alkyl groups, with 1 to 20, preferentially 1 to 4, carbon atoms in the N-alkyl residue, such as N,N′-diethyldiamine, N,N′-di-sec.-pentyldiamine, N,N′-di-sec.-hexyldiamine, N,N′-di-sec.-decyldiamine and N,N′-dicyclohexyldiamine, p- or m-phenylenediamine, N,N′-dimethyl-, N,N′-diethyl-, N,N′-diisopropyl-, N,N′-di-sec.-butyl-, N,N′-dicyclohexyl-4,4′-diaminodiphenylmethane, N,N′-di-sec.-butylbenzidine, methylene-bis(4-amino-3-benzoic acid methyl ester), 2,4-chloro-4,4′-diaminodiphenylmethane, 2,4- and 2,6-toluylenediamine can also be used. Suitable cross-linking agents are, for example, glycerin, trimethylolpropane or pentaerythritol.

Also usable are mixtures of different chain-lengthening agents and cross-linking agents with one another and also mixtures of chain-lengthening agents and cross-linking agents.

Suitable organic polyisocyanates are cycloaliphatic, araliphatic, aromatic and heterocyclic polyisocyanates such as are described, for example, by W. Siefken in Justus Liebigs Annalen der Chemie, 562, pages 75 to 136, for example those of the formula Q(NCO)ₙ in which n=2-4, preferentially 2, and Q signifies an aliphatic hydrocarbon residue with 2-18, preferentially 6-10, C atoms, a cycloaliphatic hydrocarbon residue with 4-15, preferentially 5-10, C atoms, an aromatic hydrocarbon residue with 6-15, preferentially 6-13, C atoms, or an araliphatic hydrocarbon residue with 8-15, preferentially 8-13, C atoms. Suitable are, for example, ethylene diisocyanate, 1,4-tetramethylene diisocyanate, 1,6-hexamethylene diisocyanate (HDI), 1,12-dodecane diisocyanate, cyclobutane-1,3-diisocyanate, cyclohexane-1,3- and -1,4-diisocyanate and also arbitrary mixtures of these isomers, 1-isocyanato-3,3,5-trimethyl-5-isocyanatomethylcyclohexane (DE-B 1 202 785, U.S. Pat. No. 3,401,190), 2,4- and 2,6-hexahydrotoluylene diisocyanate and also arbitrary mixtures of these isomers, hexahydro-1,3- and -1,4-phenylene diisocyanate, perhydro-2,4′- and -4,4′-diphenylmethane diisocyanate, 1,3- and 1,4-phenylene diisocyanate (DE-A 196 27 907), 1,4-durene diisocyanate (DDI), 4,4′-stilbene diisocyanate (DE-A 196 28 145), 3,3′-dimethyl-4,4′-biphenylene diisocyanate (DIBDI) (DE-A 195 09 819) 2,4- and 2,6-toluylene diisocyanate (TDI) and also arbitrary mixtures of these isomers, diphenylmethane-2,4′-diisocyanate and/or diphenylmethane-4,4′-diisocyanate (MDI) or naphthylene-1,5-diisocyanate (NDI).

Furthermore, in accordance with the invention there enter into consideration, for example: triphenylmethane-4,4′,4″-triisocyanate, polyphenyl polymethylene polyisocyanates such as are obtained by aniline-formaldehyde condensation and subsequent phosgenation and such as are described, for example, in GB-A 874 430 and GB-A 848 671, m- and p-isocyanatophenylsulfonyl isocyanates according to U.S. Pat. No. 3,454,606, perchlorinated aryl polyisocyanates such as are described in U.S. Pat. No. 3,277,138, polyisocyanates exhibiting carbodiimide groups, such as are described in U.S. Pat. No. 3,152,162 and also in DE-A 25 04 400, DE-A 25 37 685 and DE-A 25 52 350, norbornane diisocyanates according to U.S. Pat. No. 3,492,301, polyisocyanates exhibiting allophanate groups, such as are described in GB-A 994 890, in BE-B 761626 and NL-A 7102524, polyisocyanates exhibiting isocyanurate groups, such as are described, for example, in DE-C 1 022 789, DE-C 1 222 067 and DE-C 1 027 394 and also in DE-A 1 929 034 and DE-A 2 004 048, polyisocyanates exhibiting urethane groups, such as are described, for example, in BE-B 752261 or in U.S. Pat. No. 3,394,164 and U.S. Pat. No. 3,644,457, polyisocyanates exhibiting acylated urea groups according to DE-C 1 230 778, polyisocyanates exhibiting biuret groups, such as are described in U.S. Pat. No. 3,124,605, U.S. Pat. No. 3,201,372 and U.S. Pat. No. 3,124,605 and also in GB-B 889 050, polyisocyanates produced by telomerisation reactions, such as are described in U.S. Pat. No. 3,654,106, polyisocyanates exhibiting ester groups, such as are named, for example, in GB-B 965 474 and GB-B 1 072 956 and in DE-C 1 231 688, conversion products of the aforementioned isocyanates with acetals according to DE-C 1 072 385 and polyisocyanates containing polymeric fatty-acid esters according to U.S. Pat. No. 3,455,883.

It is also possible to employ the distillation residues exhibiting isocyanate groups resulting in the course of the technical production of isocyanate, optionally dissolved in one or more of the aforementioned polyisocyanates. Furthermore, it is possible to use arbitrary mixtures of the aforementioned polyisocyanates.

Preferably employed are the technically readily accessible polyisocyanates, for example 2,4- and 2,6-toluylene diisocyanate and also arbitrary mixtures of these isomers (‘TDI’), polyphenyl polymethylene polyisocyanates such as are produced by aniline-formaldehyde condensation and subsequent phosgenation (‘crude MDI’), and polyisocyanates exhibiting carbodiimide groups, urethane groups, allophanate groups, isocyanurate groups, urea groups or biuret groups (‘modified polyisocyanates’), in particular those modified polyisocyanates which are derived from 2,4- and/or 2,6-toluylene diisocyanate or from 4,4′- and/or 2,4′-diphenylmethane diisocyanate. Well suited are also naphthylene-1,5-diisocyanate and mixtures of the named polyisocyanates.

Prepolymers exhibiting isocyanate groups may also be used that are obtainable by conversion of a partial quantity or of the total quantity of the polyether ester polyols to be employed in accordance with the invention and/or of a partial quantity or of the total quantity of the isocyanate-reactive components, described above, optionally to be admixed to the polyether ester polyols to be employed in accordance with the invention with at least one aromatic diisocyanate or polyisocyanate from the group comprising TDI, MDI, DIBDI, NDI, DDI, preferentially with 4,4′-MDI and/or 2,4-TDI and/or 1,5-NDI, to form a polyaddition product exhibiting urethane groups and isocyanate groups. Such polyaddition products exhibit NCO contents from 0.05 wt. % to 40.0 wt. %.

According to an embodiment that is preferably used, the prepolymers containing isocyanate groups are produced by conversion of exclusively higher-molecular polyhydroxyl compounds, that is to say, the polyether ester polyols and/or polyether polyols, polyester polyols or polycarbonate polyols to be employed in accordance with the invention, with the polyisocyanates, preferentially 4,4′-MDI, 2,4-TDI and/or 1,5-NDI.

The prepolymers exhibiting isocyanate groups can be produced in the presence of catalysts. It is, however, also possible to produce the prepolymers exhibiting isocyanate groups in the absence of catalysts and to add these to the reaction mixture for the purpose of producing the polyurethanes.

As expanding agent to be employed optionally, component III), use may be made of water, which reacts with the organic polyisocyanates or with the prepolymers exhibiting isocyanate groups in situ, forming carbon dioxide and amino groups, which in turn react further with further isocyanate groups to form urea groups and in this case act as chain-lengthening agents. If, in order to set the desired density, water is added to the polyurethane formulation, this is ordinarily used in quantities from 0.001 wt. % to 6.0 wt. %, relative to the weight of components I), IV) and V).

As expanding agent, instead of water, or preferentially in combination with water, gases or readily volatile inorganic or organic substances that evaporate under the influence of the exothermic polyaddition reaction and advantageously have a boiling-point under normal pressure within the range from −40° C. to 120° C., preferentially from 10° C. to 90° C., can also be employed as physical expanding agents. As organic expanding agents, for example acetone, ethyl acetate, methyl acetate, halogen-substituted alkanes such as methylene chloride, chloroform, ethylidene chloride, vinylidene chloride, monofluorotrichloromethane, chlorodifluoromethane, dichlorodifluoromethane, HCFCs such as R 134a, R 245fa and R 365mfc, furthermore unsubstituted alkanes such as butane, n-pentane, isopentane, cyclopentane, hexane, heptane or diethyl ether can be used. By way of inorganic expanding agents, air, CO₂ or N₂O enter into consideration, for example. An expanding action can also be achieved by addition of compounds that decompose at temperatures above room temperature accompanied by elimination of gases, for example of nitrogen and/or carbon dioxide, such as azo compounds, for example azodicarbonamide or azoisobutyric acid nitrile, or of salts such as ammonium bicarbonate, ammonium carbamate or ammonium salts of organic carboxylic acids, for example of mono-ammonium salts of malonic acid, boric acid, formic acid or acetic acid. Further examples of expanding agents, particulars concerning the use of expanding agents, and criteria for the choice of expanding agents are described in R. Vieweg, A. Hochtlen (Editors): ‘Kunststoff-Handbuch’, Volume VII, Carl-Hanser-Verlag, Munich 1966, pp 108f, 453ff and 507-510 and also in D. Randall, S. Lee (Editors): ‘The Polyurethanes Book’, John Wiley & Sons, Ltd., London 2002, pp 127-136, pp 232-233 and p 261.

The quantity, to be expediently employed, of solid expanding agents, low-boiling liquids or gases, which in each instance may be employed individually or in the form of mixtures, for example as liquid mixtures or gas mixtures or as gas-liquid mixtures, depends on the polyurethane density being striven for and on the quantity of water employed. The requisite quantities can easily be ascertained experimentally. Satisfactory results are ordinarily provided by quantities of solid matter from 0.5 parts by weight to 35 parts by weight, preferentially 2 parts by weight to 15 parts by weight, quantities of liquid from 1 part by weight to 30 parts by weight, preferentially from 3 parts by weight to 18 parts by weight, and/or quantities of gas from 0.01 parts by weight to 80 parts by weight, preferentially from 10 parts by weight to 35 parts by weight, in each instance relative to the weight of components I), II) and of the polyisocyanates. The gas loading with, for example, air, carbon dioxide, nitrogen and/or helium can be effected either via formulation components I), II), IV) and V) and/or via the polyisocyanates.

As component IV), amine catalysts familiar to a person skilled in the art may be employed, for example tertiary amines such as triethylamine, tributylamine, N-methylmorpholine, N-ethylmorpholine, N,N,N′,N′-tetramethylethylenediamine, pentamethyldiethylenetriamine and higher homologues (DE-OS 26 24 527 and DE-OS 26 24 528), 1,4-diazabicyclo(2,2,2)octane, N-methyl-N′-dimethylaminoethylpiperazine, bis(dimethylaminoalkyl)piperazines (DE A 26 36 787), N,N-dimethylbenzylamine, N,N-dimethylcyclohexylamine, N,N-diethylbenzylamine, bis(N,N-diethylaminoethyl)adipate, N,N,N′-tetramethyl-1,3-butanediamine, N,N-dimethyl-β-phenylethylamine, bis(dimethylaminopropyl)urea, 1,2-dimethylimidazole, 2-methylimidazole, monocyclic and bicyclic amidines (DE-A 1 720 633), bis(dialkylamino)alkyl ether (U.S. Pat. No. 3,330,782, DE-B 1 030 558, DE-A 1 804 361 and DE-A 26 18 280) and also tertiary amines exhibiting amide groups (preferentially formamide groups) according to DE-A 25 23 633 and DE-A 27 32 292). By way of catalysts, Mannich bases, known as such, formed from secondary amines such as dimethylamine, and aldehydes, preferentially formaldehyde, or ketones, such as acetone, methyl ethyl ketone or cyclohexanone, and phenols, such as phenol or alkyl-substituted phenols, also enter into consideration. Tertiary amines exhibiting hydrogen atoms that are active towards isocyanate groups as catalyst are, for example, triethanolamine, triisopropanolamine, N-methyldiethanolamine, N-ethyldiethanolamine, N,N-dimethylethanolamine, the conversion products thereof with alkylene oxides such as propylene oxide and/or ethylene oxide and also secondary/tertiary amines according to DE A 27 32 292. As catalysts, furthermore silamines with carbon-silicon bonds, such as are described in U.S. Pat. No. 3,620,984, may be employed, for example 2,2,4-trimethyl-2-silamorpholiine and 1,3-diethylaminomethyltetramethyl disiloxane. Moreover, nitrogenous bases such as tetraalkylammonium hydroxides, furthermore hexahydrotriazines, also enter into consideration. The reaction between NCO groups and Tserevitinov-active hydrogen atoms is also greatly accelerated by lactams and azalactams, whereby firstly a complex forms between the lactam and the compound with acidic hydrogen.

Moreover, as catalysts (component IV) for this purpose customary organic metal compounds may be employed, preferentially organic tin compounds such as tin(II) salts of organic carboxylic acids, for example tin(II) acetate, tin(II) octoate, tin(II) ethylhexoate and tin(II) taurate and the dialkyltin(IV) salts of mineral acids or organic carboxylic acids, for example dibutyltin diacetate, dibutyltin dilaurate, dibutyltin maleate, dioctyltin diacetate and dibutyltin dichloride. In addition to these, sulfurous compounds such as di-n-octyltin mercaptide (U.S. Pat. No. 3,645,927) may also find application.

Catalysts that catalyse the trimerisation of NCO groups in special manner are employed for the purpose of producing polyurethane materials with high proportions of so-called poly(isocyanurate) structures (‘PIR foams’). Ordinarily, formulations with significant excesses of NCO groups with respect to OH groups find application for the production of such materials. PIR foams are ordinarily produced with indices from 180 to 450, the index being defined as the ratio, multiplied by the factor 100, of isocyanate groups to hydroxy groups. Catalysts that contribute to the expression of isocyanurate structures are metal salts such as, for example, potassium acetate or sodium acetate, sodium octoate and amino compounds such as 1,3,5-tris(3-dimethylaminopropyl)hexahydrotriazine.

The catalysts or catalyst combinations are, as a rule, employed in a quantity between about 0.001 wt. % and 10 wt. %, in particular 0.01 wt. % to 4 wt. %, relative to the total quantity of compounds with at least two hydrogen atoms that are reactive towards isocyanates.

In the absence of moisture and physically or chemically acting expanding agents, compact polyurethanes, for example polyurethane elastomers or polyurethane casting elastomers, may also be produced.

In the course of production of the compact or foamed polyurethanes, additives, component V), may optionally be used concomitantly. Mention may be made, for example, of surface-active additives, such as emulsifiers, foam stabilisers, cell regulators, flameproofing agents, nucleating agents, oxidation retardants, stabilisers, lubricants and mould-release agents, dyestuffs, dispersing aids and pigments. By way of emulsifiers, the sodium salts of castor-oil sulfonates or salts of fatty acids with amines such as oleate of diethylamine or stearate of diethanolamine enter into consideration, for example. Alkali salts or ammonium salts of sulfonic acids, such as, for instance, of dodecylbenzenesulfonic acid or dinaphthylmethanedisulfonic acid or of fatty acids such as ricinoleic acid or of polymeric fatty acids may also be used concomitantly as surface-active additives. By way of foam stabilisers, polyether siloxanes enter into consideration above all. These compounds are generally synthesised in such a way that copolymerisates formed from ethylene oxide and propylene oxide are bonded to a polydimethylsiloxane residue. Foam stabilisers of such a type may be either reactive towards isocyanates or unreactive towards isocyanates by virtue of etherification of the terminal OH groups. They are described, for example, in U.S. Pat. No. 2,834,748, U.S. Pat. No. 2,917,480 and U.S. Pat. No. 3,629,308. General structures of such foam stabilisers are reproduced in G. Oertel (Editor): ‘Kunststoff-Handbuch’, Volume VII, Carl-Hanser-Verlag, Munich, Vienna 1993, pp 113-115. Frequently of particular interest are polysiloxane-polyoxyalkylene copolymers that are branched via allophanate groups, according to DE-A 25 58 523. Also suitable are other organopolysiloxanes, oxyethylated alkylphenols, oxyethylated fatty alcohols and paraffin oils, and cell regulators such as paraffins, fatty alcohols and dimethylpolysiloxanes. Suitable for improving the emulsifying action, the dispersion of the filler, the cell structure and/or for the stabilisation thereof are, furthermore, oligomeric polyacrylates with polyoxyalkylene residues and fluoroalkane residues as side groups. The surface-active substances are ordinarily used in quantities from 0.01 parts by weight to 5 parts by weight, relative to 100 parts by weight of component I). Reaction retardants may also be added, for example acid-reacting substances such as hydrochloric acid, or organic acids and acid halides, and also pigments or dyestuffs and flameproofing agents known as such, for example tris(chloroethyl)phosphate, tricresyl phosphate or ammonium-phosphate and polyphosphate, furthermore stabilisers against the influences of ageing and weathering, plasticisers and fungicidally and bactericidally acting substances. Further examples of surface-active additives and foam stabilisers and also cell regulators, reaction retardants, stabilisers, flame-retardant substances, plasticisers, dyestuffs and fillers and also fungistatically and bacteriostatically active substances optionally to be used concomitantly in accordance with the invention and also particulars concerning the mode of use and mode of action of these addition agents are described in R. Vieweg, A. Höchtlen (Editors): ‘Kunststoff-Handbuch’, Volume VII, Carl-Hanser-Verlag, Munich 1966, pp 103-113.

For the purpose of producing the polyurethanes, the quantitative ratio of the isocyanate groups in the polyisocyanates to the hydrogen atoms in components I), II), Ill), IV), and V) that are reactive towards the isocyanates can be greatly varied. Customary are ratios from 0.7:1 to 5:1, corresponding to indices from 70 to 500.

For the purpose of processing the polyether esters according to the invention, the reaction components are caused to be converted with polyisocyanates by the one-stage process known as such, by the prepolymer process or by the semiprepolymer process, use being made preferentially of mechanical devices such as are described, for example, in U.S. Pat. No. 2,764,565. Particulars concerning processing devices that also enter into consideration in accordance with the invention are described in Vieweg and Höchtlen (Editors): Kunststoff-Handbuch, Volume VII, Carl-Hanser-Verlag, Munich 1966, pp 121 to 205.

In the course of the production of foam, in accordance with the invention the foaming may also be carried out in closed moulds. In this case the reaction mixture is introduced into a mould. By way of mould material, metal, for example aluminium, or plastic, for example epoxy resin, enters into consideration. In the mould the foamable reaction mixture expands and forms the moulded article. The mould foaming can in this case be carried out in such a way that the moulded part exhibits a cellular structure on its surface. But it may also be carried out in such a way that the moulded part exhibits a compact skin and a cellular core. In this context the procedure may be such that so much foamable reaction mixture is introduced into the mould that the foam that is formed just fills out the mould. But working may also proceed in such a way that more foamable reaction mixture is introduced into the mould than is necessary for filling out the interior of the mould with foam. In the last-named case, working consequently proceeds with so-called ‘overcharging’; a processing mode of such a type is, for example, known from U.S. Pat. No. 3,178,490 and U.S. Pat. No. 3,182,104.

In the course of the mould foaming frequently the mould-release agents already mentioned above are employed. These are, on the one hand, the ‘external release agents’ known as such, such as silicone oils; but, on the other hand, use may also be made of so-called ‘internal release agents’, optionally in a mixture with external release agents, as is evident, for example, from DE-OS 2 121 670 and DE-OS 2 307 589.

But foams may, of course, also be produced by block foaming or by the double-conveyor-belt process which is known as such (see ‘Kunststohandbuch’, Volume VII, Carl Hanser Verlag, Munich, Vienna, 3^{rd} Edition 1993, p 148).

The foams can be produced by various processes of block-foam manufacture or alternatively in moulds. In the course of the production of block foams, in a preferred embodiment of the invention besides the polyether polyols according to the invention those are used which exhibit a proportion of propylene oxide (PO) of at least 50 wt. %, preferably at least 60 wt. %. For the purpose of producing cold-cure moulded foams, in particular polyether polyols with a proportion of primary OH groups of more than 40 mol %, in particular more than 50 mol %, have proved worthwhile.

### EXAMPLES

### Raw Materials Employed

### Soya Oil:

Soya oil (refined, i.e. de-lecithinised, neutralised, decolourised and steam-stripped), Sigma-Aldrich Chemie GmbH, Munich, DE.

### Irganox® 1076:

Octadecyl-3-(3,5-di-tert.butyl-4-hydroxyphenyl)propionate, Ciba Specialty Chemicals (now BASF)

Production of Component A-1 in Accordance with Step (i) of the Process:
Step (i-1):

Employed as component A1) was sorbitol (as a solution in water)

Employed as component A2) was soya oil

Employed as component A3) were propylene oxide and ethylene oxide

944.8 g of a 70% solution of sorbitol in water and 2.33 g of an aqueous KOH solution (containing 44.9 wt. % KOH) were charged together in a 10 l autoclave. With stirring (450 rpm, lattice stirrer), dehydration was effected in a vacuum until a temperature of 150° C. at an absolute pressure of less than 10 mbar was attained. Then the contents of the reactor were stripped for 2 h by passing through 50 ml nitrogen/min at an absolute pressure from 100 mbar to 120 mbar. At 150° C. 1452.7 g propylene oxide were metered in within 3.43 h; in this case an absolute overall pressure of 2.45 bar was attained. After a secondary-reaction time of 1.37 h at 150° C., cooling was effected to room temperature and 3125.6 g soya oil were added through the open lid of the reactor. The reactor was freed from oxygen by threefold pressurising with nitrogen up to an absolute pressure of 3 bar and by subsequent relaxation to atmospheric pressure. After heating to 150° C., an absolute pressure of 2.8 bar was set with nitrogen and then 726.4 g ethylene oxide were metered in at a stirrer speed of 450 rpm within 2.9 h. After a secondary-reaction time of 7 h, cooling was effected to 80° C.

Step (i-2):

Directly following step (i-1), 13.64 g of a 12.12% sulfuric acid were added at 80° C. and stirred for 1 h.

Step (i-3):

Directly following step (i-2), after addition of 3.011 g IRGANOX® 1076, dehydration was effected at 110° C. for 3 h at 1 mbar (absolute pressure). A clear intermediate product (component A-1) was obtained with an OH value of 195 mg KOH/g, a viscosity of 388 mPas at 25° C. and an acid value of 216 ppm KOH.

Production of Component A-2 in Accordance with Step (i) of the Process:
Step (i-1):

Employed as component A1) was sorbitol (as a solution in water)

Employed as component A2) was soya oil

Employed as component A3) was ethylene oxide

974.3 g of a 70% solution of sorbitol in water and 2.18 g of a aqueous KOH solution (containing 44.82 wt. % KOH) were charged together in a 10 l autoclave. With stirring (450 rpm, lattice stirrer), dehydration was effected for 3 h in a vacuum at an absolute pressure of 10 mbar at 110° C. Then the contents of the reactor were stripped for 2 h by passing through 100 ml nitrogen/min at an absolute pressure from 100 mbar to 120 mbar. At 110° C. 3296.0 g soya oil were added through the open lid of the reactor. The reactor was freed from oxygen by threefold pressurising with nitrogen up to an absolute pressure of 3 bar and by subsequent relaxation to atmospheric pressure. After heating to 130° C., an absolute pressure of 2.5 bar was set with nitrogen and then 2021.5 g ethylene oxide were metered in at a stirrer speed of 450 rpm within 6.09 h. After a secondary-reaction time of 5.82 h, cooling was effected to 42° C.

Step (i-2):

Directly following step (i-1), 12.95 g of an 11.89% sulfuric acid were added at 42° C. and stirred for 1 h.

Step (i-3):

Directly following step (i-2), after addition of 2.904 g IRGANOX® 1076, dehydration was effected at 110° C. for 3 h at 1 mbar. A clear intermediate product (component A-2) was obtained with an OH value of 203 mg KOH/g, a viscosity of 486 mPas at 25° C. and an acid value of 170 ppm KOH.

### Example 1

### Conversion of Component A-1 in Accordance with Step (ii) of the Process

Employed as component B1) were propylene oxide and ethylene oxide

Employed as component B2) was DMC catalyst (produced in accordance with Example 6 of WO-A 01/80994)

In a 1 l autoclave 150 g of component A-1 and 0.025 g component B2) were submitted and, with stirring, heated up to 130° C. At this temperature, stripping was effected for 30 min at an absolute pressure <0.1 bar by means of nitrogen. Subsequently, with stirring, at 130° C. a mixture of a total of 314 g propylene oxide and 35 g ethylene oxide was metered into the reactor. For the purpose of activating the catalyst, firstly only 22 g of this mixture were added in metered amounts and the metering was then interrupted. 30 min after the start of metering the incipient activation of the catalyst was indicated by an accelerated drop in pressure in the reactor, so that the remaining quantity of epoxide could then be supplied continuously within 60 min. After a secondary reaction of 180 min up until constancy of pressure, cooling was effected to 90° C. and subsequently readily volatile portions were removed for 30 min in a vacuum at an absolute pressure of 10 mbar.

A product was obtained with an OH value of 57.5 mg KOH/g and a viscosity of 568 mPas.

### Example 2

### Conversion of Component A-1 in Accordance with Step (ii) of the Process

Employed as component B1) were propylene oxide and ethylene oxide

Employed as component B2) was DMC catalyst (produced in accordance with Example 6 of WO-A 01/80994)

In a 1 l autoclave 150 g of component A-1 and 0.015 g DMC catalyst (produced in accordance with Example 6 of WO-A 01/80994) were submitted and, with stirring, heated up to 130° C. At this temperature, stripping was effected for 30 min at an absolute pressure <0.1 bar by means of nitrogen. Subsequently, with stirring, at 130° C. a mixture of a total of 314 g propylene oxide and 35 g ethylene oxide was metered into the reactor. For the purpose of activating the catalyst, firstly only 22 g of this mixture were added in metered amounts and the metering was then interrupted. 30 min after the start of metering the incipient activation of the catalyst was indicated by an accelerated drop in pressure in the reactor, so that the remaining quantity of epoxide could then be supplied continuously within 60 min. After a secondary reaction of 180 min up until constancy of pressure, cooling was effected to 90° C. and subsequently readily volatile portions were removed for 30 min in a vacuum at an absolute pressure of 10 mbar.

A product was obtained with an OH value of 58.0 mg KOH/g and a viscosity of 541 mPas.

### Example 3

### Conversion of Component A-2 in Accordance with Step (ii) of the Process

Employed as component B1) were propylene oxide and ethylene oxide

Employed as component B2) was DMC catalyst (produced in accordance with Example 6 of WO-A 01/80994)

In a 1 l autoclave 150 g of component A-2 and 0.029 g DMC catalyst (produced in accordance with Example 6 of WO-A 01/80994) were submitted and, with stirring, heated up to 130° C. At this temperature, stripping was effected for 30 min at an absolute pressure of <0.1 bar by means of nitrogen. Subsequently, with stirring, at 130° C. a mixture of a total of 383 g propylene oxide and 43 g ethylene oxide was metered into the reactor. For the purpose of activating the catalyst, firstly only 25 g of this mixture were added in metered amounts and the metering was then interrupted. 30 min after the start of metering the incipient activation of the catalyst was indicated by an accelerated drop in pressure in the reactor, so that the remaining quantity of epoxide could then be supplied continuously within 60 min. After a secondary reaction of 180 min up until constancy of pressure, cooling was effected to 90° C. and subsequently readily volatile portions were removed for 30 min in a vacuum at an absolute pressure of 10 mbar.

A product was obtained with an OH value of 52.2 mg KOH/g and a viscosity of 716 mPas.

### Production of Component A-3 (Polymeric Alkoxylate)

### (Comparison)

811.7 g of a 70% solution of sorbitol in water and 53.33 g of an aqueous KOH solution (containing 45.00 wt. % KOH) were charged together in a 10 l autoclave. With stirring (450 rpm, lattice stirrer), dehydration was effected for 3 h in a vacuum at 125° C. Then the contents of the reactor were stripped for 2 h by passing through 50 ml nitrogen/min at an absolute pressure from 100 mbar to 120 mbar. After cooling to 107° C., 5431.8 g propylene oxide were metered in at a stirrer speed of 450 rpm within 13.53 h. After a secondary-reaction time of 3.43 h, cooling was effected to 80° C. At this temperature 306.7 g of the 45.00 wt. % KOH solution were added. Solvent water and reaction water were then removed at 125° C. with stirring (450 rpm) over a period of 3 h in a vacuum at an absolute pressure of 10 mbar. Then the contents of the reactor were stripped at this temperature for a further 2 h by passing through 50 ml nitrogen per minute at an absolute pressure from 100 mbar to 120 mbar, obtaining the polymeric alkoxylate A-3.

### Example 4 (Comparison)

### Conversion of Component A-3 in Comparison with Step (i) of the Process, No Overneutralisation, with Filtration, No Separate Step (ii)

Employed as component A1) was polymeric alkoxylate A-3

Employed as component A2) was soya oil

Employed as component A3) and B2) was propylene oxide

Employed as component B) was KOH

1601.9 g of the polymeric alkoxylate A-3 were charged in a 10 l autoclave. With stirring (450 rpm, lattice stirrer), residual oxygen was removed by threefold pressurising of the autoclave with nitrogen up to an absolute pressure of 3 bar and by subsequent evacuation to 10 mbar. After heating up to 110° C., 80.1 g propylene oxide were metered in at a stirrer speed of 450 rpm within 0.5 h. After a secondary-reaction time of 2 h, cooling was effected to 45° C. At this temperature, 741.2 g soya oil were added through the open lid of the reactor. Residual oxygen was then removed by threefold pressurising of the autoclave with nitrogen up to an absolute pressure of 3 bar and by subsequent evacuation to 10 mbar. After heating up to 105° C., 3603.5 g propylene oxide were metered into the autoclave over a period of 5.28 h. After a secondary-reaction time of 7.63 h, cooling was effected to 40° C. and 913.1 g of a 4.08% sulfuric acid were added and stirred for 1 h. Water was then removed at about 15 mbar, the temperature was meanwhile increased from 40° C. to 80° C. The precipitated salts were removed by filtration across a deep-bed filter (T 750). After addition of 2.972 g IRGANOX® 1076, thorough heating was effected at 110° C. for 3 h at 1 mbar. The reference product exhibited an OH value of 51.2 mg KOH/g, a viscosity of 593 mPas at 25° C. and an acid value of 760 ppm KOH.

### Foaming Examples

### Raw Materials Employed:

Component III): water

Component IV):
IV.1 1,4-diazabicyclo[2.2.2]octane (33 wt. %) in dipropylene glycol (67 wt. %) (Dabco® 33 LV, Air Products, Hamburg, Germany).
IV.2 bis(dimethylaminodiethyl)ether (70 wt. %) in dipropylene glycol (30 wt. %) (Niax® A I, Momentive Performance Materials, Germany).
IV.3 tin(II) salt of 2-ethylhexanoic acid (Addocat® SO, Rheinchemie, Mannheim, Germany).

Component V):
V.1 polyether-siloxane-based foam stabiliser Tegostab® BF 2370 (Evonik Goldschmidt GmbH, Germany).

Isocyanate component T180: mixture consisting of 2,4- and 2,6-TDI in a weight ratio of 80:20 and with an NCO content of 48 wt. %.

### Production of the Polyurethane Flexible Block Foams in Examples 5 to 7

Under the customary processing conditions for the production of polyurethane flexible block foams the initial components are processed in the one-stage process by means of block foaming. Specified in Table 1 is the index of the processing (according to this, the quantity of quantity to be employed of polyisocyanate component in relation to component I) results). The index (isocyanate index) specifies the percentage ratio of the isocyanate (NCO) quantity actually employed to the stoichiometric, i.e. calculated, isocyanate (NCO) quantity:

Index=[(isocyanate quantity employed):(isocyanate quantity calculated)]·100

The weight per unit volume was determined in accordance with DIN EN ISO 845.

The compressive strength (CLD 40%) was determined in accordance with DIN EN ISO 3386-1-98 at a deformation of 40%, 4^{th} cycle.

The tensile strength and the strain at break were determined in accordance with DIN EN ISO 1798.

The compression set (CS 90%) was determined in accordance with DIN EN ISO 1856-2000 at 90% deformation.

TABLE 1
Polyurethane flexible block foams; formulations and properties

| | | | | 7 |
|---|---|---|---|---|
| | | 5 | 6 | (Comparison) |
| Polyol from Example 1 | | 100 | | |
| Polyol from Example 2 | | | 100 | |
| Polyol from Example 4 | | | | 100 |
| Water | | 4.0 | 4.0 | 4.0 |
| V.1 | | 1.0 | 1.0 | 1.0 |
| IV.1 | | 0.15 | 0.15 | — |
| IV.2 | | 0.05 | 0.05 | 0.05 |
| IV.3 | | 0.18 | 0.185 | 0.19 |
| T80 | | 51.4 | 51.4 | 50.3 |
| Index | | 108 | 108 | 108 |
| Cell structure | | fine | fine | fissured |
| Bulk density | [kg/m³] | 25 | 25 | |
| Tensile strength | [kPa] | 65 | 61 | |
| Strain at break | [%] | 82 | 78 | |
| Compressive strength | [kPa] | 3.1 | 3.1 | |
| CS 90% | [%] | 7.2 | 27.7 | |

The results presented in Table 1 show that only the polyether ester polyols described in Examples 1 and 2 according to the invention exhibit good processing properties.

### Production of Components A-4, A-5 and A-6 Both by the Procedure According to the Invention (Step (i)) and by a Procedure not According to the Invention:

Production of Component A-4 (Neutralisation with 0.50 Mol Sulfuric Acid Per Mol KOH Employed)
Step (i-1):

237.1 g of a 70% solution of sorbitol in water and 0.516 g of an aqueous KOH solution (containing 44.9 wt. % KOH) were charged together in a 2 l autoclave. With stirring (800 rpm), dehydration was effected in a vacuum until a temperature of 150° C. at an absolute pressure of less than 10 mbar was attained. Then the contents of the reactor were stripped for 2 h by passing through 50 ml nitrogen/min at an absolute pressure from 100 mbar to 120 mbar. At 150° C. 363.2 g propylene oxide were metered in within 2.93 h. In this case an absolute overall pressure of 5.0 bar was attained. After a secondary-reaction time of 1.07 h at 150° C., cooling was effected to room temperature and 790 g soya oil were added through the open lid of the reactor. The reactor was freed from oxygen by threefold pressurising with nitrogen up to an absolute pressure of 3 bar and by subsequent relaxation to atmospheric pressure. After heating to 150° C., an absolute pressure of 2.5 bar was set with nitrogen and then 181.6 g ethylene oxide were metered in at a stirrer speed of 800 rpm within 5.48 h. After a secondary-reaction time of 2.6 h, cooling was effected to 80° C.

Step (i-2):

Directly following step (i-1), 0.5252 g of a 12.16% sulfuric acid were added at 80° C. to 474.4 g of the product from step (i-1) and stirred for 30 min.

Step (i-3):

Directly following step (i-2), after addition of 0.2377 g IRGANOX® 1076, dehydration was effected at 110° C. for 3 h at 8 mbar (absolute pressure). Component A-4 was obtained.

Production of Component A-5 (Neutralisation with 0.919 Mol Sulfuric Acid Per Mol KOH Employed)

Step (i-1) was carried out as described in Comparative Example 8.

Step (i-2):

Directly following step (i-1), 0.9483 g of a 12.16% sulfuric acid were added at 80° C. to 466.2 g of the product from step (i-1) and stirred for 30 min.

Step (i-3):

Directly following step (i-2), after addition of 0.2420 g IRGANOX® 1076, dehydration was effected at 110° C. for 3 h at 8 mbar (absolute pressure). Component A-5 was obtained.

Production of Component A-6 (Neutralisation with 1.255 Mol Sulfuric Acid Per Mol KOH Employed)

Step (i-1) was carried out as described in Comparative Example 8.

Step (i-2):

Directly following step (i-1), 1.4311 g of a 12.16% sulfuric acid were added at 80° C. to 514.9 g of the product from step (i-1) and stirred for 30 min.

Step (i-3):

Directly following step (i-2), after addition of 0.2584 g IRGANOX® 1076, dehydration was effected at 110° C. for 3 h at 8 mbar (absolute pressure). Component A-6 was obtained.

### (Comparative) Examples 8 to 10

### Conversion of Components A-4, A-5 and A-6 in Accordance with Step (ii) of the Process

Employed as component B1) were propylene oxide and ethylene oxide Employed as component B2) was DMC catalyst (produced in accordance with Example 6 of WO-A 01/80994)

### Comparative Example 8

### Conversion of Component A-4 in Accordance with Step (ii) of the Process

A conversion of component A-4 in accordance with step (ii) of the process according to the invention in a manner analogous to the procedure described in Example 9 was not possible, since no activation of the DMC catalyst took place within a period of 3 h. Consequently no conversion took place here in step (ii).

### Example 9

### Conversion of Component A-5 in Accordance with Step (ii) of the Process

In a 10 l autoclave 300.1 g of component A-5 and 0.033 g component B2) were submitted and, with stirring (450 rpm, lattice stirrer), heated up to 130° C. At this temperature, stripping was effected for 30 min at an absolute pressure <0.1 bar by means of nitrogen. Subsequently, with stirring, at 130° C. a mixture of a total of 686.8 g propylene oxide and 76 g ethylene oxide was metered into the reactor. For the purpose of activating the catalyst, firstly only 30 g of this mixture were added in metered amounts and the metering was then interrupted. 39 min after the start of metering the incipient activation of the catalyst was indicated by an accelerated drop in pressure in the reactor, so that the remaining quantity of epoxide could then be supplied continuously within 2.53 h. After the end of the metering of epoxide and after a secondary reaction with a duration of 0.33 h up until constancy of pressure, cooling was effected to 90° C. and subsequently readily volatile portions were removed for 30 min in a vacuum at an absolute pressure of 10 mbar.

After addition of 0.551 g IRGANOX® 1076, a clear end product was obtained with an OH value of 56.5 mg KOH/g.

### Comparative Example 10

### Conversion of Component A-6 in Accordance with Step (ii) of the Process

A conversion of component A-6 in accordance with step (ii) of the process according to the invention in a manner analogous to the procedure described in Example 9 was not possible, since no activation of the DMC catalyst took place within a period of 3 h. Consequently no conversion took place here in step (ii).

### CONCLUSION

Only the intermediate product (component A-5) neutralised by the process according to the invention can be converted further in the subsequent DMC-catalysed step with alkylene oxides (Example 9). In the case of the procedures not according to the invention (Comparative Examples 8 and 10), no activation of the DMC catalyst occurred, so no conversion of the intermediate products (components A-4 and A-6) with alkylene oxides could take place.

1. A process for producing polyether ester polyols (1) which have an OH value from 3 mg KOH/a to less than the OH value of component A) on the basis of renewable raw materials, which comprises
(i) preparing a component A) which has an OH value of at least 70 mg KOH/g, by
(i-1) reacting an H-functional starter compound A1) with one or more fatty-acid esters A2) and with one or more alkylene oxides A3) in the presence of a basic catalyst, with the concentrations of the basic catalyst being from 40 ppm to 5000 ppm, relative to the total mass of component A),
and subsequently
(i-2) neutralizing f the product from step (i-1) with sulfuric acid, wherein from 0.75 mol to 1 mol sulfuric acid per mol catalyst employed in step (i-1) are employed, and the salt arising in this connection remains in component A),
and
(ii) subsequently reacting component A) with one or more alkylene oxides B1) in the presence of a double-metal-cyanide (DMC) catalyst B2).

2. The process according to claim 1, wherein after step (i-2) in step (i-3) the removal of reaction water and of traces of water introduced with the acid is effected at an absolute pressure from 1 mbar to 500 mbar and at temperatures from 20° C. to 200° C.

3. The process according to claim 1, wherein in step (ii) a starter polyol and said DMC catalyst are initially introduced into the reactor system and component A) is supplied continuously together with one or more alkylene oxides B1).

4. The process according to claim 3, wherein in step (ii) said starter polyol comprises a partial quantity of component A) or polyether ester polyol (1) according to the invention that was previously produced separately.

5. The process according to claim 1, wherein in step (ii) the entire quantity of component A) from step (i) and DMC catalyst are introduced and one or more H-functional starter compounds are supplied continuously together with one or more alkylene oxides B1).

6. The process according to claim 1, wherein in step (ii) a starter polyol and a partial quantity of DMC catalyst are introduced into the reactor system and component A) is supplied continuously together with one or more alkylene oxides BI) and DMC catalyst and the resulting polyether ester polyol (1) is withdrawn continuously from the reactor.

7. The process according to claim 6, wherein in step (ii) said starter polyol comprises a partial quantity of component A) or polyether ester polyol (1) according to the invention that was previously produced separately.

8. The process according to claim 1, wherein said alkylene oxides A1) to be metered in step (i) contain at least 10% ethylene oxide.

9. The process according to claim 1, wherein in step (i-1) first from 5 wt. % to 95 wt. % of the quantity of one or more alkylene oxides A3) to be supplied overall in step (i-1) are reacted with an H-functional starter compound A1), subsequently one or more fatty-acid esters A2) are added in metered amounts, an then 95 wt. % to 5 wt. % of the quantity of alkylene oxide A3) to be supplied overall in step (i-1) are added in metered amounts and caused to react.

10. The process according to claim 1, wherein the DMC catalyst is employed in a concentration, relative to the quantity of polyether ester polyol (1), from 40 ppm to 1000 ppm.

11. The process according to claim 1, wherein the DMC catalyst is separated off after the alkylene-oxide addition has been concluded.

12. The process according to claim 1, wherein said one or more fatty-acid esters A2) contain no hydroxyl group.

13. A Polyether ester polyol produced by the process claim 1.

14. A process for the preparation of polyurethanes comprising reacting said polyether ester polyols according to claim 13 with at least one polyisocyanate component.

15. A polyurethane comprising the reacting product of the polyether ester polyol according to claim 13 with at least one polyisocyanate component.
